(19) United States
(12) Patent Application Publication
(10) Pub. No.: US 2016/0150407 A1
(43) Pub. Date: May 26, 2016

(54) Method And System For Connecting A Mobile Communication Device To An Automobile

(71) Applicant: Wind River Systems, Inc., Alameda, CA (US)

(72) Inventors: Bertrand MICHAUD, Alameda, CA (US); Georg DOLL, Alameda, CA (US)

(21) Appl. No.: 14/555,134

(22) Filed: Nov. 26, 2014

(51) Int. Cl. H04W 12/06; H04L 29/06; H04W 12/08

(52) U.S. Cl. CPC H04W 12/06; H04W 12/08; H04L 63/0876

(57) ABSTRACT

The present invention provides systems and methods for authenticating a mobile communication device to a computer system of an automobile that does not require manual code entry, and thereby reduces the burden on the user, minimizes human errors, and provides the ability to utilize more complex digital keys an increase the security level of the connection. In particular, the systems and methods of the present invention generate a unique identifier corresponding to the automobile and locally transfer a message including or generated from this unique identifier to the mobile communication device without manual code entry.

### FIELD OF INVENTION

The present invention relates generally to connecting a mobile communication device to a computer system. More particularly, the present invention relates to a method and system for connecting a mobile communication device to an in-vehicle informtainment (IVI) system of an automobile.

### BACKGROUND

Automobile manufacturers are increasingly integrating computer systems, such as in-vehicle informtainment (IVI) systems, to their vehicles to provide multimedia entertainment, vehicle and navigation information, and other types of computerized entertainment and assistance in automobiles. IVI systems provide enhanced user in-vehicle experiences and can link critical telematics functionality with access to multimedia and driver-defined applications.

There is an increasing trend to connect mobile communication devices, such as cell phones and smart phones to the IVI systems of an automobile. To associate a mobile communication device to an IVI system of a vehicle, a user may be given a unique code or serial number that must be manually entered. Alternatively, the user may connect to a remote operator to request that the operator manually associate the mobile communication device with the vehicle. Both of these conventional methods for associating a mobile communication device to an IVI system of an automobile are, however, cumbersome, prone to human error, and provide only limited levels of data security. Specifically, a user, particularly a less technologically savvy user, may find it burdensome to navigate through different interfaces to obtain and subsequently input a unique code or serial number. The manual reading and entering of the code or serial number can introduce error, such as, for example, misreading of the code or serial number by the user, or typographical errors upon entry. Moreover, the length of the code and serial number, which serves as a digital key to connect the mobile communication device to the vehicle, must remain short so that a user can manually enter the code or serial number within a limited amount of time. The short length of this code or serial number reduces the total number of possible permutations available, and thereby, providing a digital key that is insecure and more likely to fail in the event of a security breach.

### SUMMARY OF THE INVENTION

In accordance with the foregoing objectives and others, one embodiment of the present invention provides a method for authenticating a mobile communication device to a computer system of an automobile. The computer system may operate at least a portion of the automobile. In particular, the computer system may be an in-vehicle informtainment (IVI) system. First, the method generates a unique identifier corresponding to the automobile. The method then locally transfers a message having the unique identifier or is generated from the unique identifier to the mobile communication device. The message may be locally transferred by first generating a Quick Reference (QR) code from the unique identifier and then displaying the QR code on a screen of the computer system for image capture by the mobile communication device. The QR code may correspond to a uniform resource locator (URL) including the unique identifier. Alternatively, the message may be locally transferred via a near field communication (NFC) link between the mobile communication device and the computer system. In one embodiment, the message may be locally transferred only when the mobile communication device is located within the automobile. The method also receives via a communications network an authentication request from said mobile communication device. The authentication request includes the unique identifier or is generated from the unique identifier. The method further authenticates the mobile communication device to the computer system based on the unique identifier. The mobile communication device may be authenticated to the computer system by searching through a database for the unique identifier to identify said automobile and authorizing communications between said mobile communication device and said computer system. In certain embodiments, the method may also receive a command from said mobile communication device comprising computer-readable instructions to control the computer system, and subsequently transmit the command to the computer system of the automobile.

In another embodiment of the present invention for a method for authenticating a mobile communication device to a computer system of an automobile, the method receives via a communications network a unique identifier corresponding to the automobile from a server. The method also locally transfers a message including the unique identifier or is generated from the unique identifier to the mobile communication device. The message may be locally transferred by first generating a Quick Reference (QR) code from the unique identifier and then displaying the QR code on a screen of the computer system for image capture by the mobile communication device. The QR code may correspond to a uniform resource locator (URL) including the unique identifier. In particular, the URL may be directed to the server and the unique identifier may be embedded in the URL. The method further receives via the communications network an authentication message authorizing communications between the mobile communication device and the computer system from the server. In certain embodiments, the method may further receive a command directly from said mobile communication device comprising computer-readable instructions to control the computer system. Alternatively, the method may further receive via the communications network a command from the server. The command is first received by the server from the mobile communication device and re-transmitted by the server to the computer system.

These and other aspects of the invention will become apparent to those skilled in the art after a reading of the following detailed description of the invention, including the figures and appended claims.

### BRIEF DESCRIPTION OF THE FIGURES

FIG. 1 shows an exemplary embodiment of a system according to the present invention for authenticating a mobile communication device to a computer system.

FIG. 2 shows an exemplary embodiment of a method according to the present invention for authenticating a mobile communication device to a computer system.

### DETAILED DESCRIPTION

The present invention overcomes the deficiencies of prior systems and methods for connecting a mobile communications device to a computer system by providing systems and methods that do not require manual code entry, and thereby reducing the burden on the user, minimizing manual entry errors, and providing the ability to exchange longer and/or more complex digital keys that increase the security level of the connection. The exemplary embodiments may be further understood with reference to the following description of exemplary embodiments and the related appended drawings, wherein like elements are provided with the same reference numerals. Specifically, the exemplary embodiments relate to methods and systems for connecting and authenticating a mobile communication device to a computer system of an automobile.

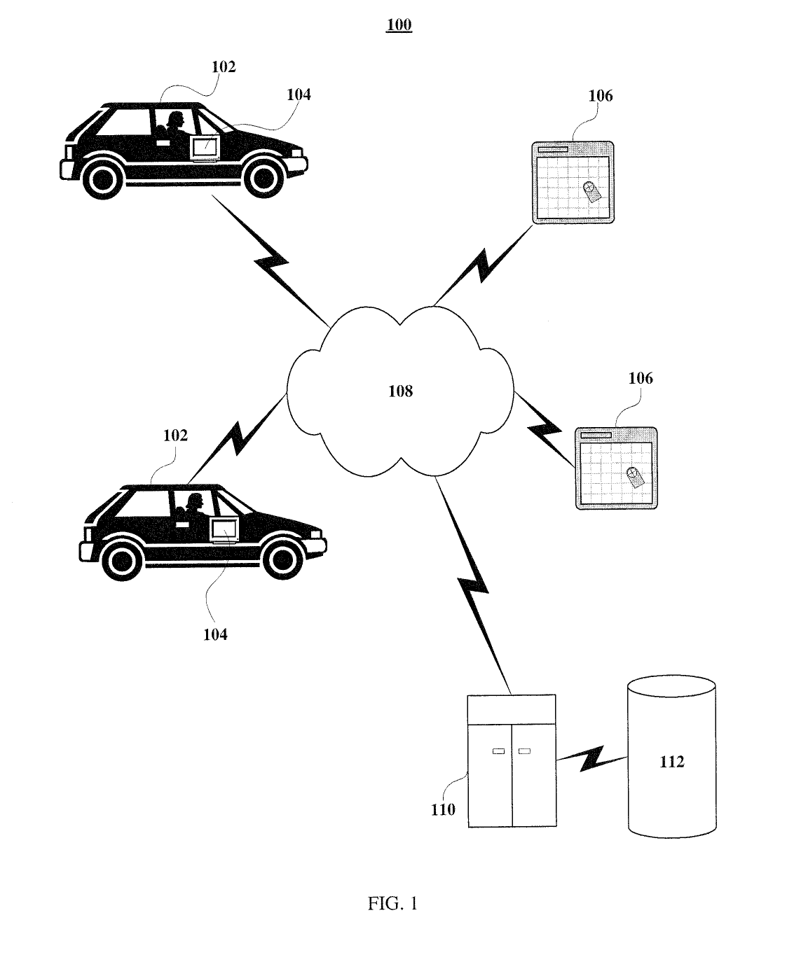

An exemplary embodiment of a system 100 according to the present invention is shown in FIG. 1. The system 100 comprises an automobile 102 having a computer system 104 therein. The computer system 104 will typically provide multimedia entertainment, navigation information, vehicle operation data, vehicle control data, other types of computerized entertainment and assistance in vehicles, or a combination thereof. The computer system 104 may control some or all of the operations of the automobile 102. The computer system 102 may be an in-vehicle informtainment (IVI) system. The computer system 104 may be in communication with a communications network 108, such as, for example, a cellular data network or the Internet. The computer system 104 may communicate with the communications network 108 through any suitable communication link. The communication link is typically wireless, e.g., cellular, Bluetooth, IEEE 802.1x, etc. In another embodiment, the communication link is a wired connection, e.g., Ethernet, serial port, Universal Serial Bus, etc.

The system 100 also comprises a mobile communication device 106 in communication with the communications network 108. Suitable mobile communication devices 106 include, for example, smart phones, cellular phones, tablets, phablets, personal digital assistants, laptops, etc. The mobile communication device 106 may also communicate with the communications network 108 through any suitable communication link. The communication link is typically wireless, e.g., cellular, Bluetooth, IEEE 802.1x, etc. In another embodiment, the communication link is a wired connection, e.g., Ethernet, serial port, Universal Serial Bus, etc.

The system 100 further includes a server 110 in communication with the communications network 108. Typically, the server 110 is located at a separate location from the automobile 102 or the mobile communication device 106. For example, the server 100 may be located in one city and the automobile 102 and mobile communication device 106 may be located in a different city. The server 110 may be in communication via the communications network 108 with one or more computer systems 104 of one or more automobiles 102 and/or one or more mobile communication devices 106. In one embodiment, the server 110 may comprise one or more computers or processors that process data and/or tasks received via the communications network 108. The server 100 is connected to a database 112. The database 112 may include any suitable data structure for storing data representing a plurality of automobiles 102 each correlated with a unique identifier, which is discussed further below. In addition, the data storage mechanism is not required to be a database, but may be any suitable data storage mechanism (e.g., an array, a table, etc.)

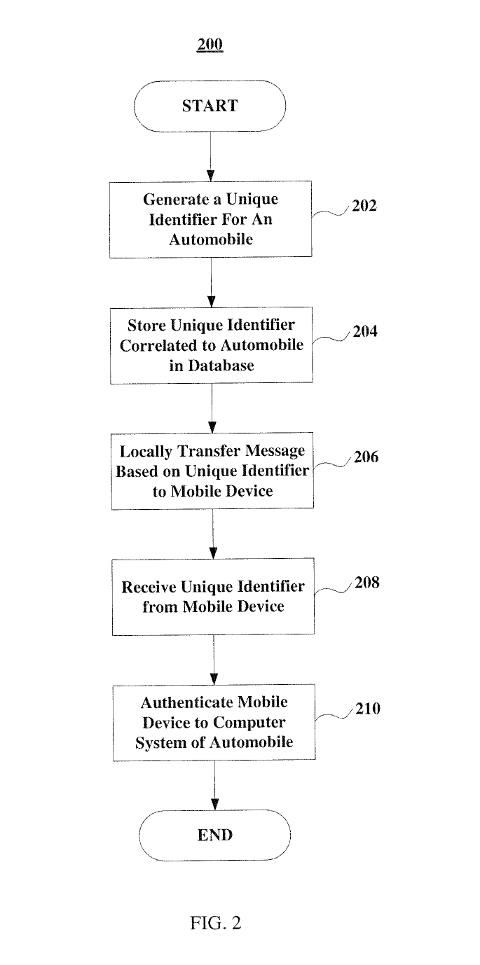

FIG. 2 illustrates an exemplary method 200 for connecting an automobile with a mobile device according to the present invention. In one exemplary embodiment, the user may initiate the method 200 by authenticating himself to the automobile 102. The user may be authenticated by any suitable means that demonstrates that he is an authorized operator of the automobile 102. For example, the user may be authenticated by placing car keys in the ignition, carrying a key fob that is wirelessly and/or contactlessly recognized by the automobile 102, providing an authorized passcode, providing authorized biometric information, etc. The user can activate the in-vehicle computer system 102 by any suitable means and initiate the exemplary method 200. For example, the user can navigate to a menu on the screen of computer system 104 and select an option that initiates the method 200.

In step 202, a unique identifier may be generated for an automobile 102. In one embodiment, the unique identifier is generated by the computer system 104 and transmitted along with identifying information, e.g., an identification number, serial number, or VIN number, for the automobile 102 via the communications network 108 to the server 110. In another embodiment, the unique identifier is generated by the server 110 and associated with identifying information for the automobile 102. For example, the server 110 may receive identifying information for the automobile 102, and subsequently generate a unique identifier for the automobile 102. More particularly, the computer system 104 of the automobile 102 may contact the server 110 via the communications network 108 with an authentication request. The authentication request may include identification information, such as, for example, an identification number, serial number, or VIN number for the automobile 102. The server 110 generates a unique identifier for the requesting automobile 102 in response to the authentication request. The server 110 may transmit the unique identifier to the computer system 104 for the requesting automobile 102 before or after step 204.

The unique identifier may be any suitable digital key or certificate for authenticating the mobile communication device 106 to the computer system 104 of the automobile 102. For example, the unique identifier may be a password, a pincode, a pattern, or a combination thereof. In some embodiments, the unique identifier may be a string of characters, numbers or letters having at least a length of 4 characters, numbers and/or letters. Typically, the unique identifier may have a length less than 8 characters, numbers and/or letters. In other embodiments, the unique identifier may be a pattern, such as a grid pattern, more specifically, a grid having certain selected blocked highlighted (e.g., a user could enter the unique identifier by highlighting the appropriate blocks). For example, the grid pattern may be in a square arrangement, such as a 4×4 or 5×5 grid, each unique identifier includes a selected pattern of blocks highlighted within the grid. In another embodiment, the unique identifier may be a sequence of pictograms. For example, the user may be prompted to select from a set of pictograms and arrange the selected pictograms in a predetermined order. A distinct unique identifier is assigned to each automobile 102. The unique identifier may expire within a predetermined amount of time after it has been generated. Typically, the unique identifier will expire in less than or within 1 hour, 2 hours, 4 hours, 6 hours, 8 hours, or 24 hours. Once the unique identifier expires, the server 110 will no longer accept the unique identifier as an authenticated digital key for communicating with the computer system 104 of the automobile 102.

In step 204, the server 110 communicates the unique identifier to the database 112. The database 112 can store data representing a plurality of automobiles 102 each correlated with its own unique identifier. For example, the database 112 may receive the unique identifier and identifying information for the automobile 102 and store both in a data structure that correlates the unique identifier with the automobile 102. In another exemplary embodiment, the database 112 may contain information for a plurality of automobiles 102, the server searches the database for an entry corresponding to the identifying information received and stores the unique identifier in a data structure that correlates it with the corresponding automobile 102. The database may also store an expiration status or expiration time associated with each unique identifier.

In another exemplary embodiment, the server 110 may generate the unique identifier prior to being contacted by the computer system 104 of the automobile 102 (step 202), and the unique identifier is stored in the database (step 204). More particularly, the computer system 104 may send an authentication request to the server 110, and the server 110 subsequently searches the database 112 for an entry corresponding to the automobile 102 based on the identification information. If the entry is found, the server 110 identifies the corresponding unique identifier and transmits the unique identifier via the communications network 108 back to the computer system 104 of the automobile 102.

In step 206, the unique identifier may be used to generate a message or data that is locally transferred from the automobile 102 to the mobile communication device 106. In one embodiment, the message or data can only be locally transferred from the automobile 102 to the mobile communication device 106. By locally, the distance between the computer system 104 and the mobile communication device 106 is typically 10 yards or less, 5 yards or less, or 3 feet or less. In some embodiments, the mobile communication device 106 is or must be within the confines of the automobile 102. In another embodiment, the distance between the computer system 104 and the mobile communication device 106 is or must be approximately arm's length, such that both the computer system 104 and the mobile communication device 106 are within arm's reach of a user. In another embodiment, the message or data is transferred upon or only upon physical contact between the mobile communication device 106 and the computer system 104.

In one particular embodiment, the unique identifier is used to generate a Quick Response (QR) code that is displayed on a screen, e.g., LCD, of the computer system 104, at least a portion of the QR code corresponds to the unique identifier or is generated as a function of the unique identifier. For example, the QR code may correspond to a uniform resource locator (URL) or web address directed to the server 110 containing the unique identifier embedded therein. The QR code may also correspond to any other message or data that includes the unique identifier or is generated as a function of the unique identifier. The data from the QR code may be locally transferred to the computer system 104 of the automobile 102 to the mobile communication device 106. In particular, the mobile communication device 106 may include a camera. The user may use the camera of the mobile communication device 106 to capture an image of the QR code displayed on the screen of the computer system 104, and thereby receiving a message or data that includes the unique identifier or is generated as a function of the unique identifier for the automobile 102.

In an alternative embodiment, the unique identifier is used to generate a message or data that is transmitted from the automobile 102 to the mobile communication device 106 via a short-ranged communication link, in particular, a near-field communication (NFC) link, such as, for example, Bluetooth, personal area networks, radio-frequency identification (RFID), ISO/IEC 14443, FeliCa, ISO/IEC 18092, etc. The short-ranged communication link may be limited to data communication networks that have a range of 10 yards or less, 5 yards or less, or 3 feet or less. In one embodiment, the short-ranged communications link has a range that is approximately arm's length, such that both the computer system 104 and the mobile communication device 106 are within arm's reach of a user. In another embodiment, the short-range communication link enables transmission of a message or data from the computer system 104 of the automobile 102 upon contact with a mobile communication device 106, at least a portion of the message or data corresponds to the unique identifier or is generated as a function of the unique identifier. In another embodiment, the unique identifier can be transmitted from the automobile 102 to the mobile communication device 106 via a wired connection, e.g., Ethernet, serial port, Universal Serial Bus, etc. The computer system 104 of the automobile 102 may be physically connected via a wire or other physical connection to transmit a message or data to the mobile communication device 106, at least a portion of the message or data corresponds to the unique identifier or is generated as a function of the unique identifier. In one particular exemplary embodiment, the message or data may correspond to a URL or web address directed to the server 110 containing the unique identifier embedded therein.

In step 208, the server 110 receives communications from the mobile communication device 106 that includes or is based on the unique identifier. In particular, the server 110 receives a message or data from the mobile communication device 106 that includes the unique identifier or is a function of the unique identifier. In one embodiment, the mobile communication device 106 processes the QR code, message, and/or data received from the computer system 104 of the automobile 102, and then transmits the unique identifier via the communications network 108 to the server 110. In one particular embodiment, the unique identifier may be extracted from the QR code and transmitted to the server 100. Alternatively, the QR code includes a URL or web address that is directed to the server 110 and contains the unique identifier embedded therein. The mobile communication device 106 may open a browser, navigates to the URL or web address, and transmit the unique identifier to the server 110.

In step 210, the server 110 compares the unique identifier received from the mobile communication device 106 to a plurality of unique identifiers each corresponding to a different automobile 102 stored within the database 112, and authenticates the mobile communication device 106 to the computer system 104. In addition, the server 110 may transmit via the communication network an authentication message to the mobile communication device 106 and/or the computer system 104 to authorizing the two to communicate with each other. It is contemplated that more than one mobile communication device 106 can be authenticated to the same automobile 102.

In an exemplary embodiment, the server 110 determines whether the unique identifier received from the mobile communication device 106 is stored within the database 112. If so, the server 110 identifies the corresponding automobile 102 based on the information stored within the database 112, and authenticates communication between the mobile communication device 106 and the computer system 104 of the identified automobile 102. The mobile communication device 106 may be authenticated by any suitable means. For example, the mobile communication device 106 may be authenticated by comparing the unique identifier with a predetermined value, e.g., a value stored within the database 112, a previously generated string, numbers, characters and/or letters, etc. In another embodiment, the mobile communication device 106 may be authenticated using cryptographic authentication, e.g., public-key cryptograph, Pretty Good Privacy (PGP) protocols, or other data encryption/decryption protocols or cryptographic algorithms, to validate the authenticity of the unique identifier. In one embodiment, the server 110 determines whether the unique identifier received from the mobile communication device 106 is stored within the database 112, and confirms that the unique identifier has not expired. If the unique identifier is found and not expired, the server 110 identifies the corresponding automobile 102 based on the information stored within the database 112, and authenticates communication between the mobile communication device 106 and the computer system 104 of the identified automobile 102.

In some embodiments, once the mobile communication device 106 is authenticated to the computer system 104 of the automobile 102, the mobile communication device 106 may directly communicate with the computer system 104 of the automobile 102 via a short-range communication link, e.g., NFC link, or via the communications network 108. In particular, the server 110 may send a message or data to both the computer system 104 and the mobile communication device 106 authorizing the two to communicate directly with each other and/or allowing the mobile communication device 106 to provide instructions to operate or control parts or all of the automobile 102. Alternatively, upon authenticating the mobile communication device 106 to the automobile 102, the server 100 may offer a software application to the mobile communication device 106 that when installed to the mobile communication device 106 authorizes it to communicate directly with the computer system 104 of the automobile 102, or otherwise enhance user experience, for example, transmitting instructions to operate and/or control of parts or all of the automobile 102 via the mobile communication device 106.

Alternatively, once the mobile communication device 106 is authenticated to the computer system 104 of the automobile 102, the mobile communication device 106 is correlated with the identified automobile 102 in the database 112. The mobile communication device 106 and the automobile 102 may be correlated by any suitable means such that a command from the mobile communications device 106 can be sent via the communications network 108 to the server 110, and subsequently re-transmitted to an authorized corresponding automobile 102 by the server 110. The command may include computer-readable instructions to control the computer system 104 of the automobile 102, such as, for example, instructions to operate and/or parts or all of the automobile 102, including instructions to honk the horn, flash headlights, lock or unlock doors, control temperature and ventilation options, control multimedia settings, control radio station selection and settings, control media player, determine navigation settings, etc.

For example, identifying information for the mobile communication device 106, such as, for example, a MAC address of the mobile communication device 106, may be transmitted to the server 110. The server 110 can correlated the mobile communication device 106 with the identified automobile 102, and the correlation is stored in the database 112. Thereafter, the mobile communication device 106 may send commands to the server 110 via the communications network 108. The server 110 may search the database 112 to identify the authorized corresponding automobile 102 and re-transmit the command to the computer system 104 of the automobile 102. If an authorized automobile 102 is not found, the command is rejected.

As described herein, the mobile communication device 106 may control all or part of the automobile 102 by providing instructions to honk the horn, flash headlights, lock or unlock doors, control temperature and ventilation options, control multimedia settings, control radio station selection and settings, control media player, determine navigation settings, etc. In some embodiments, the mobile communication device 106, after it has been authenticated, provides passengers of the automobile 102, particularly those passengers in the backseats, with improved interactivity with the computer system 104 of the automobile 102 that were not previously available in traditional vehicles. In an exemplary embodiment, the mobile communication device 106 may be authenticated and used by passengers located in the backseats of the automobile 102, e.g., behind the driver. In some situations, after the mobile communication device 106 has been authenticated to the computer system 104 of the automobile 102, passengers (e.g., backseat passengers, children, etc.) can use the mobile communication device 106 to control various settings, e.g., which movies to watch, which songs to play, without distracting the driver. In some embodiments, after the mobile communication device 106 has been authenticated to the computer system 104 of the automobile 102, the passenger may be able to search for a destination (e.g., restaurant, gas station, etc.) on the mobile communication device 106, and set the navigation system to the destination via the mobile communication device 106. In another embodiment, after the mobile communication device 106 has been authenticated to the computer system 104 of the automobile 102, the passengers may download software, e.g., install new applications or trigger a software upgrade, to the computer system 104.

Those skilled in the art will understand that the above-described exemplary embodiments may be implemented in any number of manners, including as a separate software module, as a combination of hardware and software, etc. The methods described herein may be implemented on a computer-readable medium storing a set of instructions for execution by a processor. For example, the exemplary method 200 may be embodiment in one or more programs stored in a non-transitory storage medium and containing lines of code that, when compiled, may be executed by at least one of the plurality of processor cores or a separate processor.

The invention described and claimed herein is not to be limited in scope by the specific embodiments herein disclosed since these embodiments are intended as illustrations of several aspects of this invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

What is claimed is:

1. A method for authenticating a mobile communication device to a computer system of an automobile, comprising the steps of:
generating a unique identifier corresponding to said automobile;
transferring locally a message that one of comprises the unique identifier or is generated from the unique identifier to the mobile communication device;
receiving via a communications network an authentication request from said mobile communication device, said authentication request one of comprises the unique identifier or is generated from the unique identifier; and
authenticating said mobile communication device to said computer system based on the unique identifier.

2. The method for authenticating the mobile communication device to the computer system of the automobile of claim 1, wherein said computer system operates at least a portion of the automobile.

3. The method for authenticating the mobile communication device to the computer system of the automobile of claim 1, wherein said computer system is an in-vehicle informtainment (IVI) system.

4. The method for authenticating the mobile communication device to the computer system of the automobile of claim 1, wherein said transferring step comprises:
generating a Quick Reference (QR) code from the unique identifier, and
displaying said QR code on a screen of the computer system for image capture by the mobile communication device.

5. The method for authenticating the mobile communication device to the computer system of the automobile of claim 4, wherein said QR code corresponds to a uniform resource locator (URL) comprising said unique identifier.

6. The method for authenticating the mobile communication device to the computer system of the automobile of claim 1, wherein said message is transferred via a near field communication (NFC) link between said mobile communication device and said computer system.

7. The method for authenticating the mobile communication device to the computer system of the automobile of claim 1, wherein said authenticating step comprises:
searching through a database for the unique identifier to identify said automobile; and
authorizing communications between said mobile communication device and said computer system.

8. The method for authenticating the mobile communication device to the computer system of the automobile of claim 1, further comprising:
receiving a command from said mobile communication device comprising computer-readable instructions to control the computer system; and
transmitting said command to the computer system of the automobile.

9. The method for authenticating the mobile communication device to the computer system of the automobile of claim 1, wherein said transferring step only occurs when said mobile communication device is located within the automobile.

10. A method for authenticating a mobile communication device to a computer system of an automobile, comprising the steps of:
receiving via a communications network a unique identifier corresponding to said automobile from a server;
transferring locally a message that one of comprises the unique identifier or is generated from the unique identifier to the mobile communication device; and
receiving via the communications network an authentication message authorizing communications between the mobile communication device and the computer system from said server.

11. The method for authenticating the mobile communication device to the computer system of the automobile of claim 10, wherein said computer system operates at least a portion of the automobile.

12. The method for authenticating the mobile communication device to the computer system of the automobile of claim 10, wherein said computer system is an in-vehicle informtainment (IVI) system.

13. The method for authenticating the mobile communication device to the computer system of the automobile of claim 10, wherein said transferring step comprises:
generating a Quick Reference (QR) code from the unique identifier, and
displaying said QR code on a screen of the computer system for image capture by the mobile communication device.

14. The method for authenticating the mobile communication device to the computer system of the automobile of claim 13, wherein said QR code corresponds to a uniform resource locator (URL) comprising said unique identifier.

15. The method for authenticating the mobile communication device to the computer system of the automobile of claim 13, wherein said URL is directed to the server.

16. The method for authenticating the mobile communication device to the computer system of the automobile of claim 15, wherein said unique identifier is embedded in said URL.

17. The method for authenticating the mobile communication device to the computer system of the automobile of claim 10, wherein said message is transferred via a near field communication (NFC) link between said mobile communication device and said computer system.

18. The method for authenticating the mobile communication device to the computer system of the automobile of claim 10, further comprising:
receiving a command directly from said mobile communication device comprising computer-readable instructions to control the computer system.

19. The method for authenticating the mobile communication device to the computer system of the automobile of claim 10, further comprising:
receiving via the communications network a command from said server, wherein said command is first received by the server from the mobile communication device and re-transmitted by the server to the computer system.

20. The method for authenticating the mobile communication device to the computer system of the automobile of claim 10, wherein said transferring step only occurs when said mobile communication device is located within the automobile.
